(19) United States
(12) Patent Application Publication
(10) Pub. No.: US 2014/0283100 A1
(43) Pub. Date: Sep. 18, 2014

(54) DISPLAY PRIVACY WITH DYNAMIC CONFIGURATION

(71) Applicant: Edward R. Harrison, Beaverton, OR (US)

(72) Inventor: Edward R. Harrison, Beaverton, OR (US)

(21) Appl. No.: 13/995,618

(22) PCT Filed: Mar. 15, 2013
(86) PCT No.: PCT/US13/31954

§ 371 Date: Jun. 19, 2013

(51) Int. Cl. G06F 21/60

(52) U.S. Cl. CPC G06F 21/60
USPC 726/26

(57) ABSTRACT

Generally, this disclosure provides systems, devices, methods and computer readable media for dynamic configuration of display privacy. The device may include a context determination module configured to determine a usage context for the device; a content attribute determination module configured to determine privacy attributes associated with data content to be displayed by the device; and a privacy decision module configured to trigger a privacy mode based on the usage context and the privacy attributes, the privacy decision module further configured to generate a switching signal to a switchable privacy filter in response to the privacy mode.

### FIELD

The present disclosure relates to monitor display privacy, and more particularly, to monitor display privacy with dynamic configuration based on data content and usage context.

### BACKGROUND

Computer privacy is an issue of growing importance, particularly with the increasing mobility of computing devices, such as, for example, laptops, tablets and smartphones, although it can also be of concern with desktop computers in an office setting, wherever people other than the user of the device can potentially see the display screen. Data being displayed on the device screen may be personal or business confidential in nature. Business travelers, for example, often spend long periods of time in airports and on airplanes where it may convenient to work on a portable device but where other people may be located in close proximity and able to view the display screen.

Existing solutions to this problem generally rely on the use of an add-on privacy filter which is typically a piece of plastic panel containing a micro-louver. The plastic panel is placed over or otherwise mounted on the screen, for example a liquid crystal display (LCD), to restrict the viewing angle of the screen. These filters are cumbersome and fragile, however, and generally darken the screen to an undesirable degree.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one exemplary embodiment consistent with the present disclosure;

FIG. 2 illustrates a block diagram of one exemplary embodiment consistent with the present disclosure;

FIG. 3 illustrates a block diagram of another exemplary embodiment consistent with the present disclosure;

FIG. 4 illustrates a flowchart of operations of one exemplary embodiment consistent with the present disclosure;

FIG. 5 illustrates a flowchart of operations of another exemplary embodiment consistent with the present disclosure;

FIG. 6 illustrates a system diagram showing platforms consistent with an exemplary embodiment of the present disclosure; and

FIG. 7 illustrates a flowchart of operations of another exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems, devices, methods and computer readable media for dynamic configuration of display privacy. An LCD display screen may be electronically controlled to switch between a public mode, employing a wider viewing angle, and a privacy mode, employing a narrower viewing angle. The mode switching may be based on privacy attributes detected in data content being displayed, for example, privacy tags embedded in a portable document format (PDF document) or embedded in a hypertext markup language (HTML) web page. The mode switching may also be based on a determination of a usage context of the device. The usage context may include the location of the device, for example, a private place versus a public place. In some embodiments, the usage context may include an identification of the face of a viewer of the display to determine if a non-user is in the viewing angle of the display.

FIG. 1 illustrates a top level system diagram 100 of one exemplary embodiment consistent with the present disclosure. A system with dynamic privacy mode 102 is shown coupled to a display with switchable privacy filter 104 being viewed by a user 106. The system may be any sort of computing or communication device, fixed or mobile, such as, for example, a laptop, a tablet, a smartphone or a workstation. The system with dynamic privacy mode 102 may be configured to determine a privacy mode setting based on data content to be displayed and/or usage context associated with the device or the environment in which the device is being operated, as will be explained in greater detail below. The display with switchable privacy filter 104 may be an LCD display configured with a viewing angle restriction mechanism that is electronically controllable by the system with dynamic privacy mode 102. For example, the LCD may include a switchable micro-louver or an electronically controlled birefringence switch panel which may be positioned in front of or built into the LCD display. It will be appreciated that any type of controllable privacy filter may be employed, whether currently existing or yet to be developed.

FIG. 2 illustrates a block diagram 200 of one exemplary embodiment consistent with the present disclosure. The system with dynamic privacy mode 102 is shown to include a context determination module 206, a content attribution determination module 208 and a privacy decision module 210. The context determination module 206 may be configured to determine a usage context based on an environment/context 202 associated with the device. The context may include the location of the device and a determination of whether that location is a public or crowded space as opposed to a private space. The context may include a determination of more specific locations, such as, for example and being in an airport or an aircraft. Operation of the context determination module 206 will be explained in greater detail below.

The content attribution determination module 208 may be configured to determine privacy attributes associated with data to be displayed by the device. In some embodiments, the privacy attributes may be tags embedded in the data, wherein the data may include documents, such as PDF documents, or web pages comprising HTML codes. The content attribution determination module 208 may be configured extract these tags from the PDF or HTML data.

The privacy decision module 210 may be configured to receive privacy indications provided by the context determination module 206 and the content attribution determination module 208 and determine whether or not a privacy mode should be set based on these indications. In the case of a privacy mode setting, the privacy decision module 210 may generate a display control signal to the LCD switchable privacy filter 104 to narrow the viewing angle of the display.

FIG. 3 illustrates a block diagram 300 of another exemplary embodiment consistent with the present disclosure. The context determination module 206 is shown to include sensors 302, a GPS receiver 304, a camera 306, a timer 308, a crowd size estimation module 310, a face recognition module 312 and a context estimation module 314. The sensors 302 may include an ambient air pressure sensor, an accelerometer and/or a microphone. The sensors 302 may also include (not shown) any other type of sensor, either currently existing or yet to be developed, that may provide information relevant to making a decision regarding a possible need for privacy. It will be appreciated, for example, that a proximity sensor of any type, configured to detect the presence of a person within a threshold distance, may be useful in this regard.

In some embodiments the microphone sensor 302 may be configured to determine an ambient noise level in the environment or region around the device. The noise level may be characterize or otherwise be associated with a public space or a private space. For example, a private space may be relatively quiet compared to a public space.

In some embodiments any combination of air pressure sensor, accelerometer and/or microphone may be configured to estimate that the device is located within an aircraft. For example, there may be characteristics of acceleration, air pressure changes, and sound that may be associated with aircraft operation.

In some embodiments, the GPS receiver 304 may be configured to provide a location associated with the device. The location may be known to be a public space or a private space.

In some embodiments, the camera 306 may be configured to generate an image of a region around the device. The region may include the viewing angle of the display of the device. The generated image may be provided to crowd size estimation module 310 which may be configured to estimate the number of people in the region. The generated image may also be provided to face recognition module 312 which may be configured to recognize the face, or some subset of facial features, of a person viewing the display. Face recognition module 312 may also be configured to determine if the face of the person viewing the display matches one or more faces, or facial features, associated with known users of the device.

Context estimation module 314 may be configured to receive any or all of the context data described above from the sensors 302, GPS receiver 304, crowd size estimation module 310 and/or face recognition module 312, and to combine this data in any suitable manner to estimate, or improve upon an estimate, of the usage context of the device. For example, the context estimation module 314 may determine that the device is in a location where privacy may be needed based on a combination of crowd size in the imaged region exceeding a threshold along with background noise exceeding a threshold. As another example, the context estimation module 314 may determine that the device is in a location where privacy may be needed based on a determination that the device is being operated in an aircraft where other passengers may be able to view the display screen or based on the detection of faces, other than the user, in the imaged region.

Timer module 308 may be configured to signal to context estimation module 314 that a pre-defined time interval has expired since the last context estimation update and that new sensor readings, and other context inputs, may be obtained for a the generation of a new context estimation.

FIG. 4 illustrates a flowchart of operations 400 of one exemplary embodiment consistent with the present disclosure. The device may be in an original mode of operation 410, which may be a privacy mode or a public mode. At operation 430, a user opens a document 420 which may include privacy tags. The document may be, for example, a PDF document, a Word document or an HTML (or other type) of web page capable of containing tags. At operation 440, a determination is made, based on the document tags, whether the document is private. If the document is public, a public mode is set at operation 450. If the document is private, a private mode is set at operation 460. At operation 470, the user closes the document and, at operation 480, the original mode is re-instated.

FIG. 5 illustrates a flowchart of operations 500 of another exemplary embodiment consistent with the present disclosure. At operation 510, the device usage context is analyzed. If the analysis indicates that privacy is required 520, then the private mode is set at operation 540, otherwise the public mode is set at operation 530. A timer signals, at operation 550, that a new context analysis update should be performed and the loop is repeated at operation 510.

FIG. 6 illustrates a system diagram 600 showing platforms consistent with an exemplary embodiment of the present disclosure. A platform 602 may be a mobile device, such as, for example, a smartphone, a tablet or a laptop computing device. In some embodiments, platform 602 may be a desktop computer or workstation. In some embodiments, platform 602 may include a processor 604, memory 606, an input/output (I/O) system 608 and a network interface 610. The platform may also include a dynamic privacy mode system 102 and a display with switchable privacy filter 104 as described previously.

FIG. 7 illustrates a flowchart of operations 700 of another exemplary embodiment consistent with the present disclosure. The operations provide a method for dynamic configuration of display privacy. At operation 710, a usage context for a device is determined At operation 720, privacy attributes are determined. The privacy attributes are associated with data content to be displayed. At operation 730, a privacy mode is triggered. The privacy mode is based on the usage context and the privacy attributes. At operation 740, a display switching signal is generated. The display includes a switchable privacy filter configured to restrict the viewing angle of the display. The switching signal is generated in response to the privacy mode.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may include, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides systems, devices, methods and computer readable media for dynamic configuration of display privacy. The following examples pertain to further embodiments.

In Example 1, a device may include a context determination module configured to determine a usage context for the device. The device of this example may also include a content attribute determination module configured to determine privacy attributes associated with data content to be displayed by the device. The device of this example may further include a privacy decision module configured to trigger a privacy mode based on the usage context and the privacy attributes, the privacy decision module further configured to generate a switching signal to a switchable privacy filter in response to the privacy mode.

In Example 2, the subject matter of Example 1 can optionally include the foregoing components and the switchable privacy filter is configured to restrict the viewing angle of the display.

In Example 3, the subject matter of any one of Examples 1-2 can optionally include the foregoing components and the privacy attributes include tags embedded in the data content, the data content including a document or a web page.

In Example 4, the subject matter of any one of Examples 1-3 can optionally include the foregoing components and the context determination module includes a GPS receiver configured to determine a location of the device, the location associated with a public space or a private space, the privacy mode triggered in response to the public space determination.

In Example 5, the subject matter of any one of Examples 1-4 can optionally include the foregoing components and the context determination module includes a camera configured to generate an image of a region within the viewing angle of the display.

In Example 6, the subject matter of any one of Examples 1-5 can optionally include the foregoing components and the context determination module further includes a crowd size estimation module configured to estimate a number of people in the imaged region, the privacy mode triggered in response to the number of people exceeding a threshold.

In Example 7, the subject matter of any one of Examples 1-6 can optionally include the foregoing components and the context determination module further includes a face recognition module configured to recognize a face in the imaged region, the privacy mode triggered in response to the recognized face differing from a face associated with an authorized user of the device.

In Example 8, the subject matter of any one of Examples 1-7 can optionally include the foregoing components and the context determination module further includes a microphone configured to measure ambient noise associated with the device being in a public space location, the privacy mode triggered in response to the public space determination.

In Example 9, the subject matter of any one of Examples 1-8 can optionally include the foregoing components and the context determination module further includes an accelerometer configured to measure acceleration of the device exceeding a threshold associated with operation of the device in an aircraft, the privacy mode triggered in response to the aircraft operation determination.

In Example 10, the subject matter of any one of Examples 1-9 can optionally include the foregoing components and the context determination module further includes a timer configured to trigger a context determination at pre-defined intervals of time.

According to another aspect there is provided a method. Optional features of the device described above may also be implemented with respect to the method described herein. In Example 11, the method may include determining a usage context for a device. The method of this example may also include determining privacy attributes associated with data content to be displayed. The method of this example may further include triggering a privacy mode based on the usage context and the privacy attributes. The method of this example may further include generating a switching signal to a switchable privacy filter in response to the privacy mode.

In Example 12, the subject matter of Example 11 can optionally include the foregoing operations and the switchable privacy filter is configured to restrict the viewing angle of the display.

In Example 13, the subject matter of any one of Examples 11-12 can optionally include the foregoing operations and determining privacy attributes further includes extracting a tag embedded in the data content, the data content including a document or a web page.

In Example 14, the subject matter of any one of Examples 11-13 can optionally include the foregoing operations and determining a usage context further includes determining a location of the device based on a GPS receiver, the location associated with a public space or a private space, and triggering the privacy mode in response to the public space determination.

In Example 15, the subject matter of any one of Examples 11-14 can optionally include the foregoing operations and determining a usage context further includes generating an image of a region within the viewing angle of the display; estimating a number of people in the imaged region; and triggering the privacy mode in response to the number of people exceeding a threshold.

In Example 16, the subject matter of any one of Examples 11-15 can optionally include the foregoing operations and determining a usage context further includes generating an image of a region within the viewing angle of the display; recognizing a face in the imaged region; and triggering the privacy mode in response to determining that the recognized face differs from a face associated with an authorized user of the device.

In Example 17, the subject matter of any one of Examples 11-16 can optionally include the foregoing operations and determining a usage context further includes measuring ambient noise associated with the device being in a public space location, and triggering the privacy mode in response to the public space determination.

In Example 18, the subject matter of any one of Examples 11-17 can optionally include the foregoing operations and determining a usage context further includes measuring acceleration of the device exceeding a threshold associated with operation of the device in an aircraft, the privacy mode triggered in response to the aircraft operation determination.

According to another aspect there is provided a system. In Example 19, the system may include means for determining a usage context for a device. The system of this example may also include means for determining privacy attributes associated with data content to be displayed. The system of this example may further include means for triggering a privacy mode based on the usage context and the privacy attributes. The system of this example may further include means for generating a switching signal to a switchable privacy filter in response to the privacy mode.

In Example 20, the subject matter of Example 19 can optionally include the foregoing components and the switchable privacy filter is configured to restrict the viewing angle of the display.

In Example 21, the subject matter of any one of Examples 19-20 can optionally include the foregoing components and determining privacy attributes further includes means for extracting a tag embedded in the data content, the data content including a document or a web page.

In Example 22, the subject matter of any one of Examples 19-21 can optionally include the foregoing components and determining a usage context further includes means for determining a location of the device based on a GPS receiver, the location associated with a public space or a private space, and means for triggering the privacy mode in response to the public space determination.

In Example 23, the subject matter of any one of Examples 19-22 can optionally include the foregoing components and determining a usage context further includes means for generating an image of a region within the viewing angle of the display; means for estimating a number of people in the imaged region; and means for triggering the privacy mode in response to the number of people exceeding a threshold.

In Example 24, the subject matter of any one of Examples 19-23 can optionally include the foregoing components and determining a usage context further includes means for generating an image of a region within the viewing angle of the display; means for recognizing a face in the imaged region; and means for triggering the privacy mode in response to determining that the recognized face differs from a face associated with an authorized user of the device.

In Example 25, the subject matter of any one of Examples 19-24 can optionally include the foregoing components and determining a usage context further includes means for measuring ambient noise associated with the device being in a public space location, and means for triggering the privacy mode in response to the public space determination.

In Example 26, the subject matter of any one of Examples 19-25 can optionally include the foregoing components and determining a usage context further includes means for measuring acceleration of the device exceeding a threshold associated with operation of the device in an aircraft, the privacy mode triggered in response to the aircraft operation determination.

According to another aspect there is provided, in Example 27, at least one computer-readable storage medium having instructions stored thereon which when executed by a processor, cause the processor to perform the operations of the method as described in any of the examples above.

According to another aspect there is provided, in Example 28, an apparatus including means to perform a method as described in any of the examples above.

Specifics in the examples above may be used may be used anywhere in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-19. (canceled)

20. A device for dynamic configuration of display privacy, said device comprising:
a context determination module configured to determine a usage context for said device;
a content attribute determination module configured to determine privacy attributes associated with data content to be displayed by said device; and
a privacy decision module configured to trigger a privacy mode based on said usage context and said privacy attributes, said privacy decision module further configured to generate a switching signal to a switchable privacy filter in response to said privacy mode.

21. The device of claim 20, wherein said switchable privacy filter is configured to restrict the viewing angle of said display.

22. The device of claim 20, wherein said privacy attributes comprise tags embedded in said data content, said data content comprising a document or a web page.

23. The device of claim 20, wherein said context determination module comprises a global positioning system (GPS) receiver configured to determine a location of said device, said location associated with a public space or a private space, said privacy mode triggered in response to said public space determination.

24. The device of claim 20, wherein said context determination module comprises a camera configured to generate an image of a region within said viewing angle of said display.

25. The device of claim 24, wherein said context determination module further comprises a crowd size estimation module configured to estimate a number of people in said imaged region, said privacy mode triggered in response to said number of people exceeding a threshold.

26. The device of claim 24, wherein said context determination module further comprises a face recognition module configured to recognize a face in said imaged region, said privacy mode triggered in response to said recognized face differing from a face associated with an authorized user of said device.

27. The device of claim 20, wherein said context determination module further comprises a microphone configured to measure ambient noise associated with said device being in a public space location, said privacy mode triggered in response to said public space determination.

28. The device of claim 20, wherein said context determination module further comprises an accelerometer configured to measure acceleration of said device exceeding a threshold associated with operation of said device in an aircraft, said privacy mode triggered in response to said aircraft operation determination.

29. The device of claim 20, wherein said context determination module further comprises a timer configured to trigger a context determination at pre-defined intervals of time.

30. A method for dynamic configuration of display privacy, said method comprising:
determining a usage context for a device;
determining privacy attributes associated with data content to be displayed;
triggering a privacy mode based on said usage context and said privacy attributes;
generating a switching signal to a switchable privacy filter in response to said privacy mode.

31. The method of claim 30, wherein said switchable privacy filter is configured to restrict the viewing angle of said display.

32. The method of claim 30, wherein determining privacy attributes further comprises extracting a tag embedded in said data content, said data content comprising a document or a web page.

33. The method of claim 30, wherein determining a usage context further comprises determining a location of said device based on a GPS receiver, said location associated with a public space or a private space, and triggering said privacy mode in response to said public space determination.

34. The method of claim 30, wherein determining a usage context further comprises generating an image of a region within said viewing angle of said display;
estimating a number of people in said imaged region; and triggering said privacy mode in response to said number of people exceeding a threshold.

35. The method of claim 30, wherein determining a usage context further comprises generating an image of a region within said viewing angle of said display;
recognizing a face in said imaged region; and triggering said privacy mode in response to determining that said recognized face differs from a face associated with an authorized user of said device.

36. The method of claim 30, wherein determining a usage context further comprises measuring ambient noise associated with said device being in a public space location, and triggering said privacy mode in response to said public space determination.

37. The method of claim 30, wherein determining a usage context further comprises measuring acceleration of said device exceeding a threshold associated with operation of said device in an aircraft, said privacy mode triggered in response to said aircraft operation determination.

38. A computer-readable storage medium having instructions stored thereon which when executed by a processor result in the following operations for dynamic configuration of display privacy, said operations comprising:
determining a usage context for a device;
determining privacy attributes associated with data content to be displayed;
triggering a privacy mode based on said usage context and said privacy attributes;
generating a switching signal to a switchable privacy filter in response to said privacy mode.

39. The computer-readable storage medium of claim 38, wherein said switchable privacy filter is configured to restrict the viewing angle of said display.

40. The computer-readable storage medium of claim 38, wherein determining privacy attributes further comprises the operation of extracting a tag embedded in said data content, said data content comprising a document or a web page.

41. The computer-readable storage medium of claim 38, wherein determining a usage context further comprises the operations of determining a location of said device based on a GPS receiver, said location associated with a public space or a private space, and triggering said privacy mode in response to said public space determination.

42. The computer-readable storage medium of claim 38, wherein determining a usage context further comprises the operations of generating an image of a region within said viewing angle of said display; estimating a number of people in said imaged region; and triggering said privacy mode in response to said number of people exceeding a threshold.

43. The computer-readable storage medium of claim 38, wherein determining a usage context further comprises the operations of generating an image of a region within said viewing angle of said display; recognizing a face in said imaged region; and
triggering said privacy mode in response to determining that said recognized face differs from a face associated with an authorized user of said device.

44. The computer-readable storage medium of claim 38, wherein determining a usage context further comprises the operations of measuring ambient noise associated with said device being in a public space location, and triggering said privacy mode in response to said public space determination.

45. The computer-readable storage medium of claim 38, wherein determining a usage context further comprises the operation of measuring acceleration of said device exceeding a threshold associated with operation of said device in an aircraft, said privacy mode triggered in response to said aircraft operation determination.
